(19) United States
(12) Patent Application Publication
(10) Pub. No.: US 2005/0027714 A1
(43) Pub. Date: Feb. 3, 2005

(54) Scheduling and execution of program jobs in computer system

(75) Inventor: Christopher Norman Kline, Firestone, CO (US)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION

(21) Appl. No.: 10/632,620

(22) Filed: Jul. 31, 2003

(51) Int. Cl. G06F 17/00

(52) U.S. Cl. 707/100

(57) ABSTRACT

A system, method and program product for managing a change to an application, operating system, data base or other software component of a computer system. At one location, such as a server where the change is to be made, a user schedules execution or installation of the change. The change is implemented by a change program, and the syntax of the change program is checked at a time that the user schedules execution or installation of the change. Subsequently, a program automatically attempts to execute or install the change as scheduled. Then, the tool automatically conducts a search for a key phrase or code associated with the attempt to execute or install the change to determine if the change was successful or unsuccessful. The key phrase or code may be stored in a log associated with the application, operating system, data base or other software component. Subsequently, the tool sends a notification of success or lack of success to another location, such as a pager or e-mail address of the user. Thus, the user does not have to be physically present at the server when the change is implemented, but will be notified whether there is a problem.

### BACKGROUND OF THE INVENTION

The invention relates generally to computer systems, and deals more particularly with scheduling and execution of jobs which change programs or other software components within a computer system.

Systems administrators are often required to make configuration and other changes to computer systems, such as creating new queues, adjusting permissions for accessing files, connecting to applications, sending and retrieving application messages, manipulating application objects, and tuning changes to application instances. Heretofore, the systems administrators have made such changes by manually entering commands or initiating scripts in real time to implement the changes. For example, to create a new queue, the systems administrator has entered commands or initiated a script which identified an application instance which is the target of the change, and issued change commands via an application interface. In the case of IBM WebSphere MQ application, such changes were made via a “runmqsc” utility. To identify the application instance, the systems or application administrator performed the following steps: a) extracting configured instance names and primary data locations from an application master configuration file; b) quering the operating system to see which of the application instances is running; and c) querying the running application instances (or at least the instance to which the change should be made) to verify each instance is responsive and not hung. The systems administrator then made a change to the application instance, either manually or via a prepared script, and verified that the change was made successfully by manually checking the output of the change and searching for certain codes and phrases in output either displayed on the screen or stored in temporary logs. As another example of how a systems administrator made a change in real time to adjust permissions, the systems administrator has entered commands or initiated a script which issued operating system commands. The systems administrator verified that the change was made successfully by reviewing the output of those commands, as well as the exit status of each command.

Systems administrators are also often required to run other types jobs such as creating or removing application instances, installing an application package, tuning network connections, cleaning disk space (such as for logs), and performing other application-specific maintenance tasks. The systems administrators have run such jobs by manually entering commands or initiating scripts in real time to implement the change. For example, to install an application package, the systems administrator has typically installed it manually (without automation). The systems administrator has verified that the jobs have been successfully run by manually reviewing output from such activities for any anomalies. Sometimes such changes are requried en masse (to many systems simultaneously). Without extra personpower, such changes had to be made in a serial fashion, consuming much time.

To minimize the impact on the system's users, the foregoing types of jobs were typically run during maintenance “windows” which were late at night or on weekends when there was relatively little need for the system. Unfortunately, this has placed a burden on the systems administrators who must then work “odd” hours.

Accordingly, an object of the present invention is to automate the process of making configuration and other changes to computer systems.

Another object of the present invention is to automate the process of running jobs on a computer system.

### SUMMARY OF THE INVENTION

The present invention resides a system, method and program product for managing a change to an application, operating system, data base or other software component of a computer system. At one location, such as a server where the change is to be made, a user schedules execution or installation of the change. Subsequently, a program automatically attempts to execute or install the change as scheduled. Then, the tool automatically conducts a search for a key phrase or code associated with the attempt to execute or install the change to determine if the change was successful or unsuccessful. Subsequently, the tool sends a notification of success or lack of success to another location, such as a pager or e-mail address of the user. Thus, the user does not have to be physically present at the server when the change is implemented, but will be notified whether there is a problem.

According to another feature of the present invention, the key phrase or code is stored in a log associated with the application, operating system, data base or other software component.

According to another feature of the present invention, the change is implemented by a change program, and the syntax of the change program is checked at a time that the user schedules execution or installation of the change.

### BRIEF DESCRIPTION OF THE FIGURES

FIG. 1 is a block diagram of a computer system including a job scheduling and executing program embodying the present invention.

FIG. 2 is a flow chart of the job scheduling and executing program of FIG. 1.

FIG. 3 is a more detailed flow chart of a function within the job scheduling and executing program of FIG. 2 which interacts with the systems administrator to obtain parameters for a scheduled job, and gets necessary system support for that interaction.

FIG. 4 is a detailed flow chart of a function within the function of FIG. 3 to identify application instances in the system of FIG. 1.

FIG. 5 is a more detailed flow chart of a function within the job scheduling and executing program of FIG. 2 which schedules the job with the operating system and displays a corresponding confirmation to the systems administrator.

FIGS. 6(A) and 6(B) form a flow chart illustrating a job executing function within the job scheduling and executing program of FIG. 1.

### DETAILED DESCRIPTION OF THE PREFERRED EMBODIMENTS

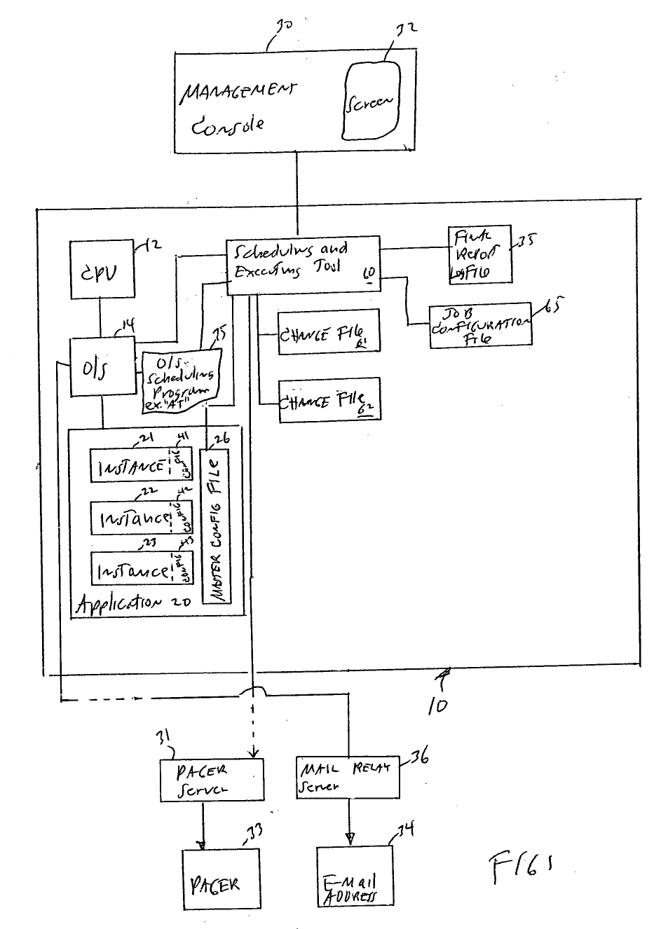

Referring now to the drawings in detail wherein like reference numbers indicate like elements throughout, FIG. 1 illustrates a computer system generally designated 10 according to one embodiment of the present invention. Computer system 10 comprises system hardware including a CPU 12 and system software including an operating system 14. By way of example, the operating system can be UNIX, Linux, or Microsoft Windows. An application 20 is installed in system 10. By way of example, application 20 can be IBM WebSphereMQ middleware application which facilitates the exchange of messages between different applications having the same or different formats and protocols. Alternately, application 20 can be any of a wide range of applications such as data base management, transaction manager, enterprise application integration, web content manager, etc. In the illustrated embodiment, there are multiple instances 21, 22 and 23 of application 20, where each “instance” can have a different configuration and is identified by a different name/number. (An instance of IBM WebSphere MQ application is called a “Queue Manager”.) Each instance can run concurrently on operating system 14. Computer system 10 includes a master configuration file 26 for application 20. Configuration file 26 contains the following information: names of application instances, the default settings for each application instance (i.e. default log threshold settings, file system locations, directories, name prefixes, default communication parameters etc.). Application instances 21, 22 and 23 include respective application instance-specific configuration files 41, 42 and 43 which contains the following information for each instance: locations of logs and data directories, authorization settings, communications settings, channel limits, and other instance-wide configuration settings. FIG. 1 also illustrates a management console 30 (including a display 32) for system 10. A systems administrator uses management console 30 to log on to and control system 10. The foregoing hardware and software components of system 10 are known in the prior art, and their types are not critical to the present invention.

In accordance with the present invention, system 10 also includes a job scheduling and executing program tool 60. Tool 60 schedules execution of change files such as change files 61 and 62. By way of example, the change files are program scripts but could also be SQL database scripts or operating system commands (or even program binaries that do something to the overall system or application). (A “script” is a user interface to an operating system, usually command-line based, which translates user input into instructions the operating system can understand, then conveying operating system output back to the user interface.) The systems administrator creates change files 61 and 62 before use of tool 60. The following are examples of change files in the form of scripts which (a) change configuration, (b) create new queues, and (c) adjust application permissions. Examples (i) and (ii) below are application-specific syntax that is passed into an application-specific interface program such as “runmqsc” with WebSphere MQ:
i) alter qlocal(TEST.QUEUE) maxdepth(10000) maxmsgl(26214400)
ii) define qlocal(NEW.QUEUE) descr(‘a new queue for an example’)
iii) /usr/mqm/bin/setmqaut -m QMGR -t queue -n TEST.QUEUE -g groupI -all+browse+get+inq+put

As explained in more detail below, tool 60 (a) verifies the syntax of each of the change files before execution or installation, (b) schedules the execution or installation of change files 61 and 62 (usually to take place during a maintenance window of system 10), (c) attempts to execute or install the change files when scheduled, (d) verifies whether the change files 61 and 62 were successfully executed or installed, and then (e) notifies the systems administrator preferrably by pager or e-mail (or by voice synthesized telephone call or SNMP trap) whether the change was successful. Tool 60 performs the verification by checking logs, associated with a changed application, for key phrases and codes or by checking exit status for changes to an operating system.

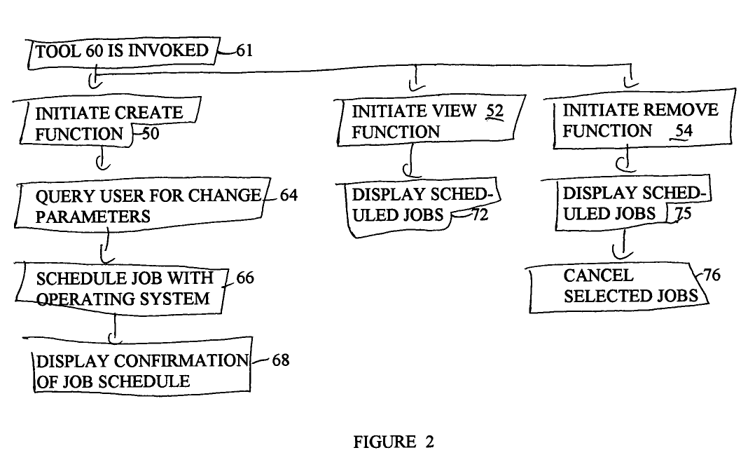

FIG. 2 illustrates functions of tool 60 prior to execution of the change files. When the systems administrator invokes tool 60 (step 61), he or she does so with a command type such as “create” 50 (i.e. schedule a change file for execution or installation), “view” 52 (i.e. display all jobs currently scheduled), or “remove” 54 (i.e. delete currently scheduled jobs) to indicate the desired function of the tool. If the systems administrator does not enter a valid command, tool 60 displays default help information or an explanation on how to use tool 60.

If the systems administrator entered the “create” command when invoking tool 60 (step 50), then tool 60 will query the systems administrator to enter the following “change” parameters—name of a change file for an application instance, a general summary of the change file in text form, name of an application instance which is the target of the change file, date and time that the change file should be executed or installed (step 64). In some cases, a change will be needed for the operating system 14 or other program within system 10 to be compatible with or support the changed application. In such a case, if the systems administrator indicates such a change is to be included in the job, tool 60 will query the systems administrator for the same type of “change” parameters for the operating-system change (step 64). Next, tool 60 schedules the job with the operating system by writing the change parameters entered by the systems administrator to a job configuration file 65, and issuing a scheduling command to the operating system which specifies the date and time to run the change file(s) (step 66). There is one job configuration file 65 per job. Next, tool 60 verifies and confirms to the systems administrator that the job was properly scheduled (step 68).

Referring again to step 60, if the systems administrator entered “view” when invoking tool 60 (step 52), then tool 60 queries the operating system for a list of currently scheduled jobs. The operating system keeps a list of all scheduled jobs for all users. After the operating system furnishes this list to tool 60, tool 60 displays the list on console 30 to the systems administrator (step 72).

Referring again to tool 60, if the systems administrator entered the “remove” command when invoking tool 60, (step 54), then tool 60 queries the operating system for all scheduled jobs and displays this list to the user. If the user selects from the display any or all of the scheduled jobs for cancellation, then the tool 60 issues a cancellation command (“AT” in UNIX and Microsoft Windows operating systems) to an operating system scheduling program 75 for the specified jobs (step 76).

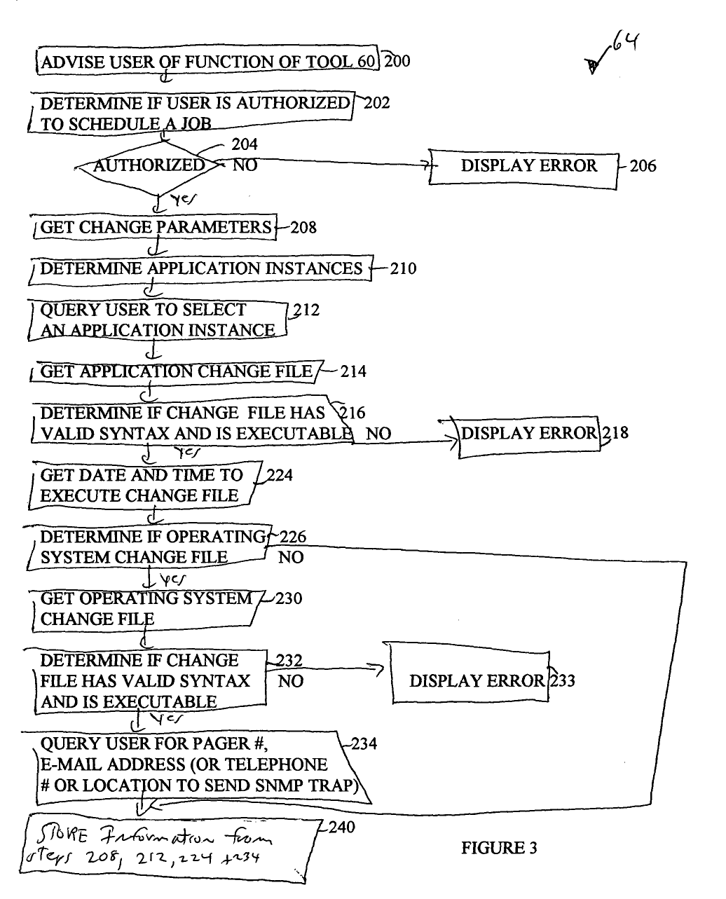

FIG. 3 illustrates step 64 of FIG. 2 in more detail, i.e. the interaction with the systems administrator to obtain the change parameters, and getting necessary system support for that interaction. Initially, tool 60 advises the user of the intended purpose of the tool—to make a change to an application, data base or other software component within system 10 (step 200). Then, tool 60 queries the operating system to determine if the systems administrator has authority/privilege to access a (prior art) job scheduler routine within the operating system 14 (step 202). This determination is made by the “AT” utility 75 and supporting files on Unix and Microsoft Windows operating systems. If not (decision 204, no branch), tool 60 displays an error message to the systems administrator that the systems administrator is not authorized to schedule a change job (step 206). If so (decision 204, yes branch), tool 60 queries the systems administrator for the following change parameters: name of an application to be changed, name of a change file for the application, general summary of the change file, date and time that the change file should be executed or installed, and if needed, a name of a change file for the operating system to change the operating system to comply with the changes to the application (step 208). Based on the name of the application to be changed, tool 60 identifies the instances of the specified application and displays a list of these instances to the systems administrator (step 210). Then, tool 60 queries the systems administrator to select one instance as the target for the change file (step 212). Based on the name of the change file, tool 60 reads the named change file into memory (step 214), and then checks the syntax of the named change file and whether it is executable by the operating system (step 216). Tool 60 checks the syntax of the change file by executing the change file in a known “verify” mode (in the UNIX or Microsoft Windows operating systems). A change file is “executable” if it is a program which the operating system has authority to execute and is able to execute (i.e. the “x” permission on Unix and a “.exe” , “.bat”, or “.com” file extension for Microsoft Windows.). This determination is made by tool 60 querying the operating system with a known command, either to the operating system directly or via some sort of application interface (ex. “runmqsc” with WebSphere MQ). If the syntax is faulty or the change file is not executable (step 216, no branch), tool 60 displays a corresponding error message to the systems administrator (step 218). However, if the syntax is correct and the change file is executable (step 216, yes branch), then tool 60 queries the systems administrator for the date and time to execute or install the change file (step 224). If the systems administrator entered parameters for another change file for the operating system (decision 226, yes branch), then tool 60 reads this other change file into memory (step 230). Then, tool 60 checks the syntax of this other change file and whether this other change file is executable, in the same manner as above (step 232). If not, then tool 60 displays an error message to the systems administrator on console 30 (step 233). If so, then tool 60 queries the systems administrator for the manner of notifying the systems administrator of the outcome after tool 60 later attempts to execute or install the change file (step 234). The manner of notification can be by pager number, e-mail address, telephone number or SNMP trap to a specified device. Tool 60 stores all the information collected in steps 208, 212, 224 and 234 for later incorporation into a job configuration file (step 240).

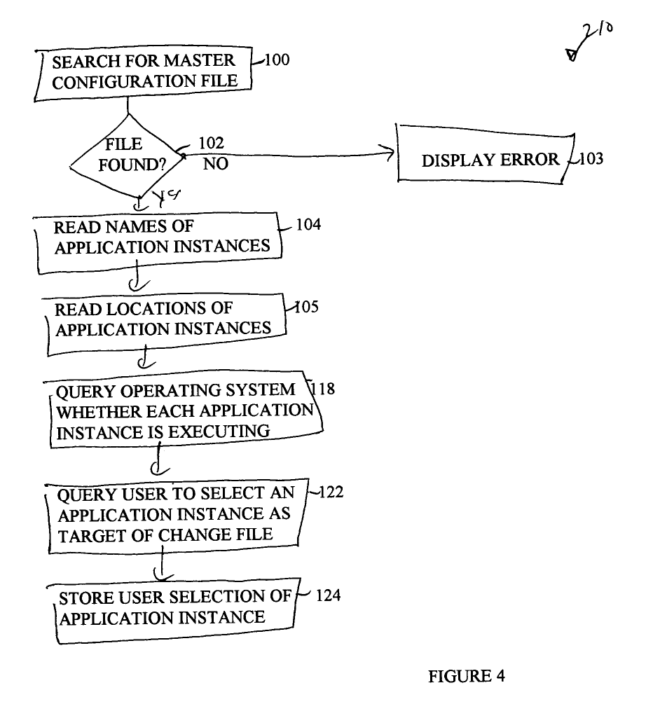

FIG. 4 illustrates step 210 of FIG. 3 in more detail, i.e. the identification of the application instance. In step 100, tool 60 searches for the application master configuration file 26 at a predetermined location. If tool 60 does not find the master configuration file 26 (decision 102, no branch), then tool displays an error message (step 103). Referring again to decision 102, if tool 60 finds the application master configuration file 26, then tool 60 reads the names and then the locations of all instances 21, 22 and 23 of application 20 that are currently installed (steps 104 and 105). If no instances are currently installed, then tool 60 displays a message that no instances of application 20 are currently installed and the tool exits. Referring again to decision 104, assuming there is at least one instance of application 20 currently installed, tool 60 queries the operating system to determine whether these instances are currently executing (step 118). Also, tool 60 tests each of the executing application instances, such as with an application “ping” query (for example, using a “runmqsc” command when querying WebSphere MQ instances), to confirm that the application instance is responsive (step 120). (The nature of the query is not important; it is only intended to determine if the application instance is responsive.) Next, tool 60 displays a list of the application instances (and an indication if they are currently executing) and queries the systems administrator at console 30 to select one or more of the application instances as the target of the change file (step 122). Tool 60 then records the user selection (step 124).

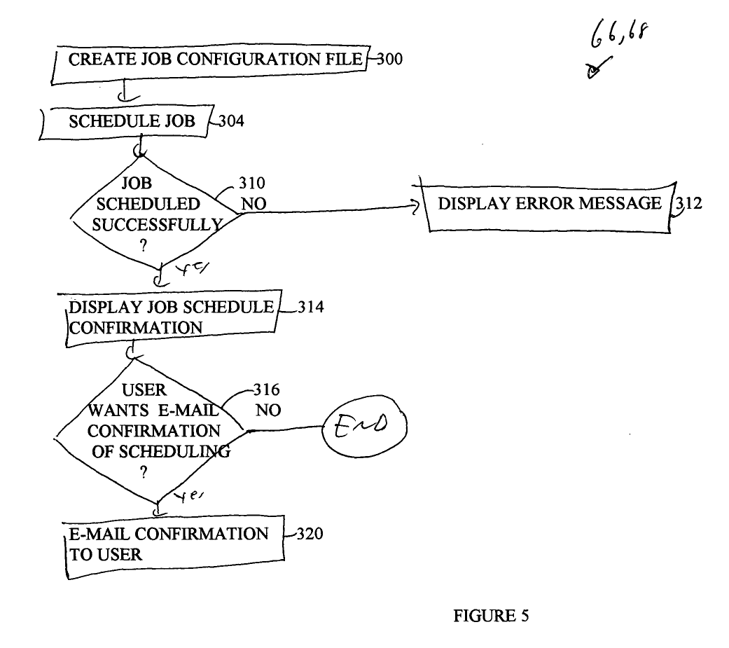

FIG. 5 illustrates in more detail steps 66 and 68 of FIG. 2—scheduling the job with the operating system and displaying a corresponding schedule confirmation to the systems administrator. As explained above, steps 66 and 68 are performed after the systems administrator enters the change parameters. Then, tool 60 creates a job configuration file for the requested change by gathering the change parameters stored by the systems administrator in step 240 of FIG. 3, and then naming a job configuration file for this job and writing the information into the job configuration file (step 300). Next, tool 60 schedules the job by writing the change parameters into the job configuration file, and notifying the operating system with a “schedule” command as to the date and time to execute the job (step 304). Next, tool 60 determines if the job was successfully scheduled by checking the return code from the operating system schedule command (decision 310). If the job was not successfully scheduled, tool 60 displays an error message to the systems administrator (step 312). If the job was successfully scheduled, then tool 60 displays on console 30 a confirmation of the job sheduling (step 314). If the systems administrator requested by e-mail confirmation of job execution (decision 316), then tool 60 displays a job confirmation notice with all the information that the systems administrator previously entered. Tool 60 then queries the user to determine whether to send a copy of the confirmation to a specified e-mail address as a reminder of the scheduled job and also as a test to make sure that e-mail is indeed getting from the target system to the system administrator (a good test for making sure that e-mail/pager alerts can be properly dispatched at change time) (step 320). The same e-mail address may be used later to notify the systems administrator whether the job was successfully executed or installed, so it is helpful to confirm this e-mail address during the scheduling phase.

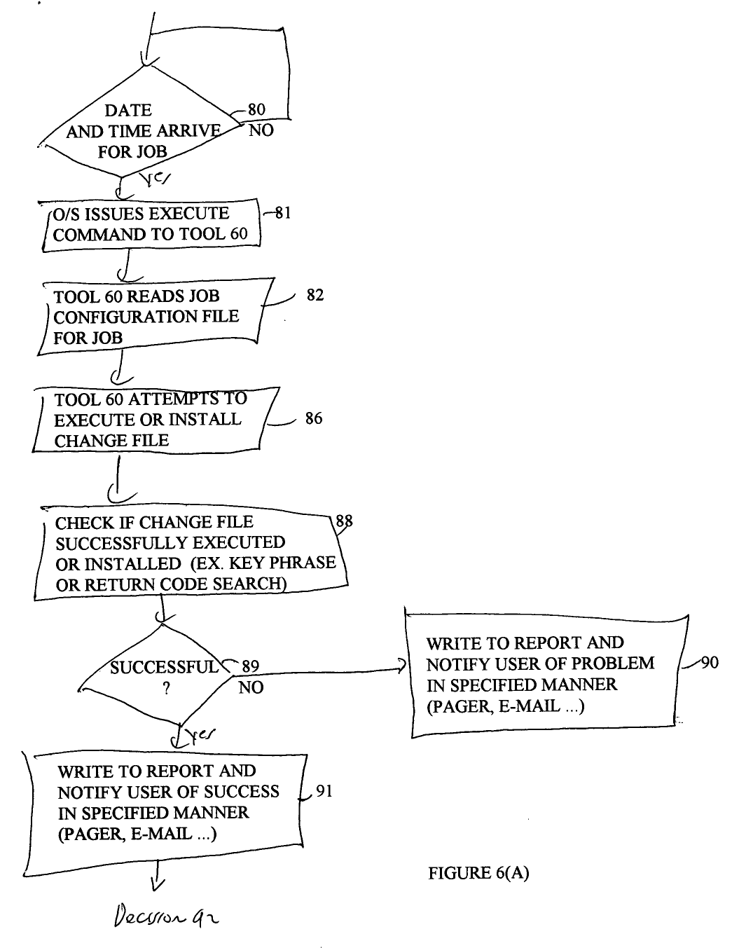

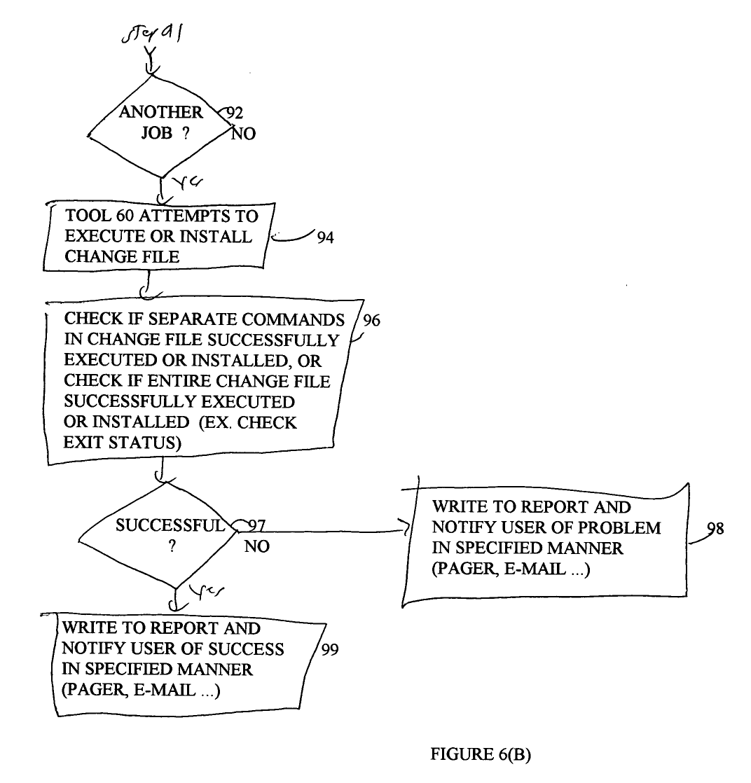

FIGS. 6(A) and 6(B) illustrate subsequent operation of tool 60, when initiated by the operating system, to execute or install a scheduled job. When the operating system determines that the date and time for a scheduled job occurs (decision 80), then the operating system invokes tool 60 with an “Execute” command (step 81). The Execute command includes the name of the job configuration file which defines the job to be run at that date and time. In response, tool 60 reads the job configuration information (step 82), and validates that the job configuration is complete and valid. It so, then tool 60 attempts to execute or install (as appropriate) the change file specified therein for the target application or application instance (or other program) (step 86). Then, tool 60 checks whether the change intended by the change file to the application or application instance (or other program) was successful (steps 88 and 89). In the case of changes to an application, application instance or certain types of other programs, tool 60 performs this check by automatically conducting searches for key phrases or return codes in logs associated with the changes. For example, if the change file is to change a setting for a queue of an application instance (where the setting is the number of messages that can reside on the queue), after the change is attempted, the application instance will write to a log file a return code indicating “successful” or “unsuccessful”. Tool 60 searches for this return code in the log to determine the result. As another example, if the operating-sytem change file is to change permissions (i.e. which userIDs have which type of access to specified files), after the change is made, the tool will make such changes and then query the exit status after each command to determine whether it was successful. All changes, both application changes and operating system changes, are completely logged for later review. Tool 60 has access to a table of the returns codes and phrases that indicate successful or unsuccessful execution of the change file. This table can be provided by the author of tool 60 or by the systems administrator at console 30 when creating the respective job. Tool 60 stores the results (i.e. successful or unsuccessful) in final report log 35 and then sends them to the systems administrator's pager 33 or e-mail address 34 (typically a workstation) (or by telephone or SNMP trap) (step 90 for unsuccessful or step 91 for successful). To send a pager notification to the systems administrator's pager, tool 60 creates an e-mail and sends the e-mail to the pager's e-mail address, for example, 1234567@pager.com. A (prior art) pager server 31 receives this e-mail, then converts the e-mail to an alphanumeric form compatible with the pager, and then sends the converted e-mail to the systems administrator's pager 33. To send an e-mail notification to the systems administrator's workstation 34, tool 60 makes a (prior art) command to the operating system 14 and includes in the command the information for the e-mail, i.e. address and content. In UNIX and Windows operating systems, this command is called “sendmail”. The operating system then forwards the e-mail to a mail relay server 36 via the Internet, which in turn, forwards it to the destination workstation 34 via the Internet.

In those cases where another change is required, such as a corresponding change to the operating system (decision 92, yes branch)), there will be another change file specified in the job configuration file. In such a case, tool 60 attempts to execute or install (as appropriate) this other change file for the operating system (step 94). Then, tool 60 checks whether the changes intended by the change file(s) to the operating system were successful (step 96 and decision 97). Tool 60 can perform this check by automatically checking for an “exit status” code (in UNIX operating system), for each command in the operating system change file (or another response code for the entire change file). The exit status indicates a successful or unsuccessful execution of the respective command in the change file. (An “exit status” is similar to a return code, except a return code generally comes from an application whereas an exit status generally comes from a “shell” of the operating system. An operating system shell is a command interpreter which runs on the operating system. In the UNIX operating system, common shells are“sh,” as well as “ksh,” “csh,” and “bash.”. In the Windows operating system, the shell is called “command.com”.) In the Unix operating system, the shell returns an exit status of “0” if the command executed successfully and some other integer if not successful. Tool 60 stores the results of the attempt to execute each command in the operating system change file (i.e. successful or unsuccessful) in a final report log 35 (step 98 for unsuccessful and step 99 for successfull). Tool 60 also correlates the command and respective exit status to the specific change attempted to be made to the operating system. This correlation is made by checking each command's output for success or failure. For example, if the change file includes several commands to several, respective files in the operating system, and one of the changes to one respective operating system file was unsuccessful, then tool 60 will record in the final report that this one change to a named operating system file was unsuccessful. Then, tool 60 sends the report file to the systems administrator by pager or e-mail (or by telephone or SNMP trap) (step 98).

If a systems administrator receives no alert as to the disposition of the change within approximately five minutes after the scheduled change time, the systems administrator may assume that something went wrong with the change and should log on to manually determine the case. Otherwise, notification of either change success or failure should be sent immediately to the system administrator, thereby eliminating any uncertainty as to the outcome.

If a change to an application is successful, but the corresponding change, if any, to the operating system is unsuccessful, then in one embodiment of the present invention, the change to the application is not undone. It will be the responsibility of the systems administrator, after receiving the report file sent by the tool 60, to manually investigate and initiate a correction of the problem with the operating system. In many cases, the changed application can still execute despite the inability to completely change the operating system as specified in the operating system change file. In another embodiment of the present invention, tool 60 will attempt execution or installation of the change file for the operating system before the scheduled change to the application, and if the change to the operating system is not completely successful or not successful enough to support the proposed changed to the application, then tool 60 will cancel the scheduled change to the application. Tool 60 can determine if the change to the operating system is sufficient to support the scheduled change to the application by executing such commands in a verification mode that is common to many existing operating system commands.

Based on the foregoing, a tool for managing change files according to one embodiment of the present invention has been disclosed. However, numerous modifications and substitutions can be made without deviating from the scope of the present invention. For example, there are other ways to confirm whether a change to programs was successful. Therefore, the invention has been disclosed by way of illustration and not limitation, and reference should be made to the following claims to determine the scope of the present invention.

1. A method for managing a change to an application, operating system, data base or other software component of a computer system, said method comprising the steps of:
at one location, a user scheduling execution or installation of said change;
subsequently, automatically attempting to execute or install said change as scheduled, and then automatically conducting a search for a key phrase or code associated with the attempt to execute or install said change to determine if said change was successful or unsuccessful; and
subsequently, sending a notification of success or lack of success to another location.

2. A method as set forth in claim 1 wherien said one location is local to said system.

3. A method as set forth in claim 1 wherein said one location is a console for said system.

4. A method as set forth in claim 1 wherein said sending step is performed by pager or e-mail to said other location.

5. A method as set forth in claim 4 wherein said notification is sent by said pager or e-mail to said user.

6. A method as set forth in claim 3 wherein said sending step is performed by pager or e-mail.

7. A method as set forth in claim 1 wherein said change is implemented by a script file.

8. A method as set forth in claim 1 wherein key phrase or code is stored in a log associated with said application, operating system, data base or other software component.

9. A method as set forth in claim 1 wherein said change is implemented by a change program, and further comprising the step of checking syntax of said change program at a time that said user schedules execution or installation of said change.

10. A computer program product for managing a change to an application, operating system, data base or other software component of a computer system, said computer program product comprising:
a computer readable medium;
first program instructions for enabling a user at a server to schedule execution or installation of said change;
second program instructions for subsequently, automatically attempting to execute or install said change as scheduled, and then automatically conducting a search for a key phrase or code associated with the attempt to execute or install said change to determine if said change was successful or unsuccessful; and
third program instructions for subsequently, sending a notification of success or lack of success to a pager or e-mail address remote from said server; and wherein
said first, second and third program instructions are recorded on said medium.

11. A method as set forth in claim 10 wherein said user owns or possesses said pager or e-mail address.

12. A method as set forth in claim 10 wherein said change is implemented by a script file.

13. A method as set forth in claim 10 wherein key phrase or code is stored in a log associated with said application, operating system, data base or other software component.

14. A method as set forth in claim 10 wherein said change is implemented by a change program, and further comprising fourth program instructions for checking syntax of said change program at a time that said user schedules execution or installation of said change, and wherein said fourth program instructions are recorded on said medium.

15. A system for managing a change to an application, operating system, data base or other software component of a computer system, said system comprising:
means, local to a server, for enabling a user to schedule execution or installation of said change;
means, local to said server, for subsequently, automatically attempting to execute or install said change as scheduled, and then automatically conducting a search for a key phrase or code associated with the attempt to execute or install said change to determine if said change was successful or unsuccessful; and
means, local to said server, for subsequently, sending a notification of success or lack of success to a remote location.

16. A system as set forth in claim 15 wherein said remote location is a pager or e-mail address.

17. A system as set forth in claim 16 wherein said user owns or possesses said pager or e-mail address.

18. A system as set forth in claim 15 wherein said change is implemented by a script file.

19. A system as set forth in claim 15 wherein key phrase or code is stored in a log associated with said application, operating system, data base or other software component.

20. A system as set forth in claim 15 wherein said change is implemented by a change program, and further comprising means for checking syntax of said change program at a time that said user schedules execution or installation of said change.
